(19) United States
(12) Patent Application Publication
(10) Pub. No.: US 2002/0076053 A1
(43) Pub. Date: Jun. 20, 2002

(54) Communication system, its control method, program and medium

(76) Inventor: Futoshi Hachimura, Kanagawa (JP)

Correspondence Address: ROBIN BLECKER & DALEY, 2ND FLOOR, 330 MADISON AVENUE, NEW YORK, NY, 10017, US

(21) Appl. No.: 09/990,001

(22) Filed: Nov. 21, 2001

(30) Foreign Application Priority Data
Nov. 28, 2000 (JP) 361285/2000

(51) Int. Cl. H04L 9/00

(52) U.S. Cl. 380/277

(57) ABSTRACT

It is made possible to read an encrypted Web E-mail from a different information terminal device. A server for providing a Web E-mail service to a client has a management function for managing a secret key and a decrypting function in a public key cryptosystem, and the service is realized by decrypting the E-mail encrypted by the public key cryptosystem and transmitting to the information terminal device.

### BACKGROUND OF THE INVENTION

1. Field of the Invention

The present invention relates to an E-mail (referred to as a Web E-mail in this specification) service as a contents service displayable on a Web (World Wide Web) browser, and more particularly, it relates to its security technology.

2. Related Background Art

In recent years, there is seen a marked trend to regard security as important in communication between an information terminal and an application server, and various kinds of encryption communication protocols are used in accordance with various applications. In particular, encryption communication by a public key cryptosystem is most frequently used. In the case where this public key cryptosystem is used for Web contents, an encryption protocol called a Secure Sockets Layer (SSL) is often used. In this Web encryption system, as a world standard encryption protocol of the next generation, a protocol called a Transport Layer Security (TLS) is being used.

Moreover, in an E-mail, it has been considered to encrypt by a system called a Pretty Good Privacy (PGP) or a Secure Multipurpose Internet Mail Extensions (S/MIME). With this encryption system of E-mail, it is possible to acquire the E-mail encrypted by a public key using a dedicated E-mail application (also called a mailer) on an information terminal, read a received mail by encrypting it using a secret key saved in the information terminal, or transmit a prepared mail by signing it using said secret key.

Furthermore, up to recently, as a system considering convenience of a mobile information terminal, not by reading an E-mail from a specific terminal, by authentication means through a Web browser, by setting up a personal mail box on an application server (a server of a provider, for example), without using a dedicated E-mail application, there is realized an application server for providing an E-mail (Web E-mail) service as a contents service displayable on the Web browser. Generally, since a Web browser application is more generally used than the dedicated E-mail application, there is the primary factor that the Web E-mail service such as this is provided.

### SUMMARY OF THE INVENTION

However, in the case where an encryption communication is carried out in the Web E-mail service, if a secret key is saved in the information terminal as usual, it is possible to read the decrypted Web E-mail only from the information terminal where such secret key is saved, and it is not possible to effectively utilize the convenience of the Web E-mail accessible from a number of other information terminals.

The present invention is invented in view of such background, and a subject thereof is to enable to read the Web E-mail encrypted from a number of information terminals.

In order to solve the aforesaid subject, in this embodiment, a server for providing the Web E-mail service to the information terminal (client) comprises a management function for managing the secret key in aforesaid public cryptosystem and a decryption function, and is structured to decrypt the E-mail encrypted by the public key cryptosystem.

Other features and advantages of the patent invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a structural diagram of a communication system to which a first embodiment of the present invention is applied.

FIG. 2 is a block diagram showing a schematic structure of an information terminal.

FIG. 3 is a block diagram showing a schematic structure of an application server.

FIG. 4 is a diagram showing an example of a window of the information terminal in the case where a Web E-mail service of the application server is accessed by a Web browser of the information terminal.

FIG. 5 is a diagram showing an example of the window of the information terminal in the case where a mail in a receiving box of the Web E-mail is opened.

FIG. 6 is a diagram showing an example of an allowance authentication window for use of secret key sent from the application server and displayed on the information terminal when the decryption software button is pressed.

FIG. 7 is a diagram showing an example of the window of the information terminal in the case where the authentication allowance for use of secret key is succeeded and an encryption Web E-mail is decrypted.

FIG. 8 is a diagram showing an example of the window of the information terminal in the case where a new E-mail is created after the authentication allowance for use of secret key is succeeded.

FIG. 9 is a diagram showing an example of the window of the information terminal in the case where a signature software button is pressed and a digital signature is executed on the Web E-mail after a new E-mail is created.

FIG. 10 is a flow chart showing a processing of the information terminal of the first embodiment of the present invention.

FIG. 11 is a flow chart continued from FIG. 10.

FIG. 12 is a flow chart showing a processing of the application server in the first embodiment of the present invention.

FIG. 13 is a flow chart continued from FIG. 12.

FIG. 14 is a flow chart showing a signature processing in the information terminal.

FIG. 15 is a flow chart showing a signature processing in the application server.

FIG. 16 is a structural diagram of a communication system to which a second embodiment of the present invention is applied.

FIG. 17 is a flow chart showing a processing of the information terminal in the second embodiment of the present invention.

FIG. 18 is a flow chart continued from FIG. 17.

FIG. 19 is a flow chart showing a processing of the application server in the second embodiment of the present invention.

FIG. 20 is a flowchart continued from FIG. 19.

### DETAILED DESCRIPTION OF THE PREFERRED EMBODIMENT

The present invention will hereunder be described further with reference to the drawings which show the embodiments thereof.

First Embodiment

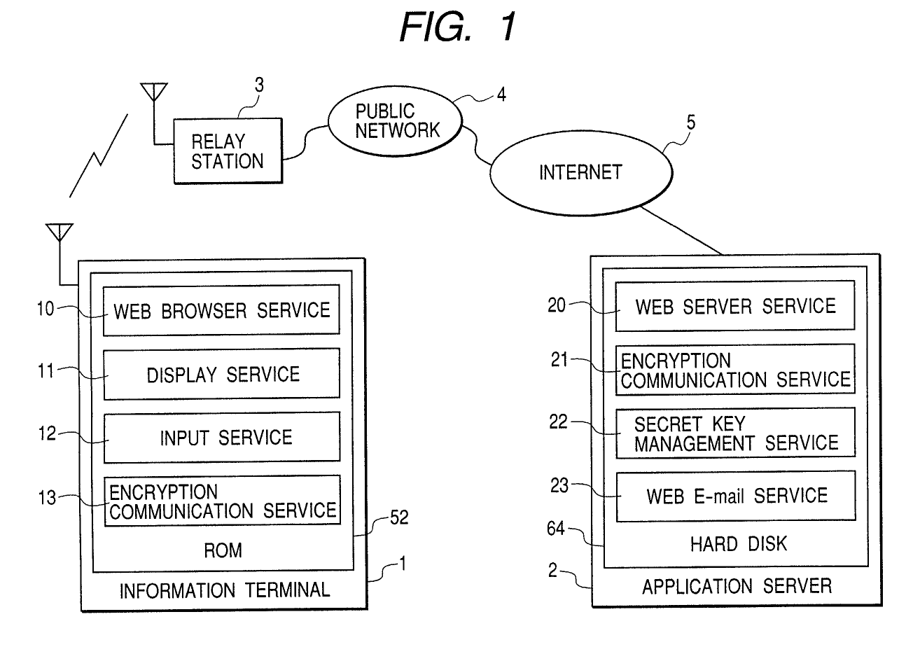

FIG. 1 is a structural diagram of a communication system to which a first embodiment of the present invention is applied wherein an information terminal 1 is connected to an application server 2 through a Web including a relay station 3, a public network 4 and an Internet 5. Furthermore, the information terminal 1 is connected in advance to the Internet 5 by a protocol such as a Point-to-Point Protocol (PPP).

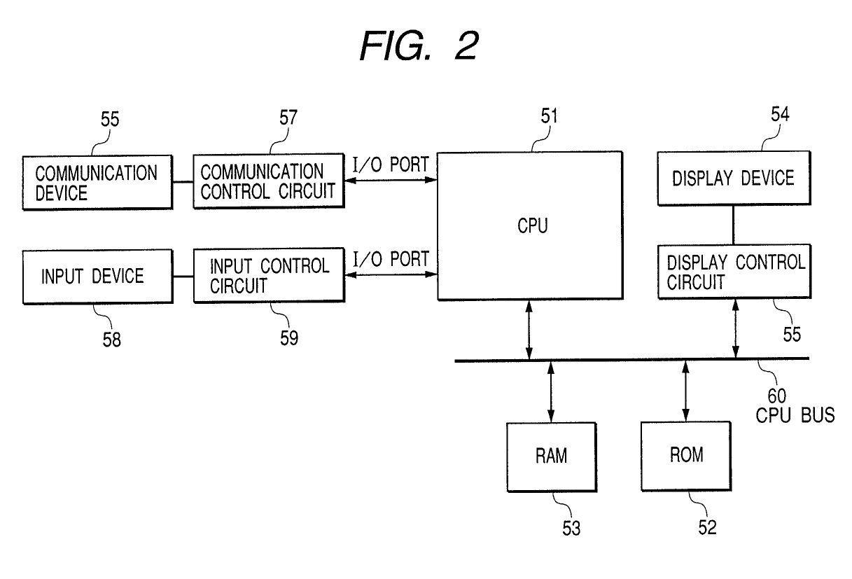

The information terminal 1 (Personal Digital Assistant, for example), as shown in FIG. 2, comprises a CPU 51, a ROM 52, and a RAM 53. Furthermore, the information terminal 1 comprises a display device 54 consisting of a liquid crystal panel, a back light, an optical system and the like, this display device 54 is controlled and driven by a display control circuit 55. These CPU 51, ROM 52, RAM 53 and display control circuit 55 are connected through a CPU bus 60.

Furthermore, the CPU 51 is connected, through an I/O port, to a communication device 56 and a communication control circuit 57 for communication with an external apparatus, and an input device 58 and an input control circuit 59 for receiving instructions from user.

With such structure described above, the CPU 51, while utilizing the RAM 53 as a work area and the like, based on a program stored in the ROM 52, various processings corresponding to various services such as a telephone service, a Web browser service, and a Web E-mail service are carried out. Further, the ROM 52 may be other storage medium such as a flash memory or a hard disk.

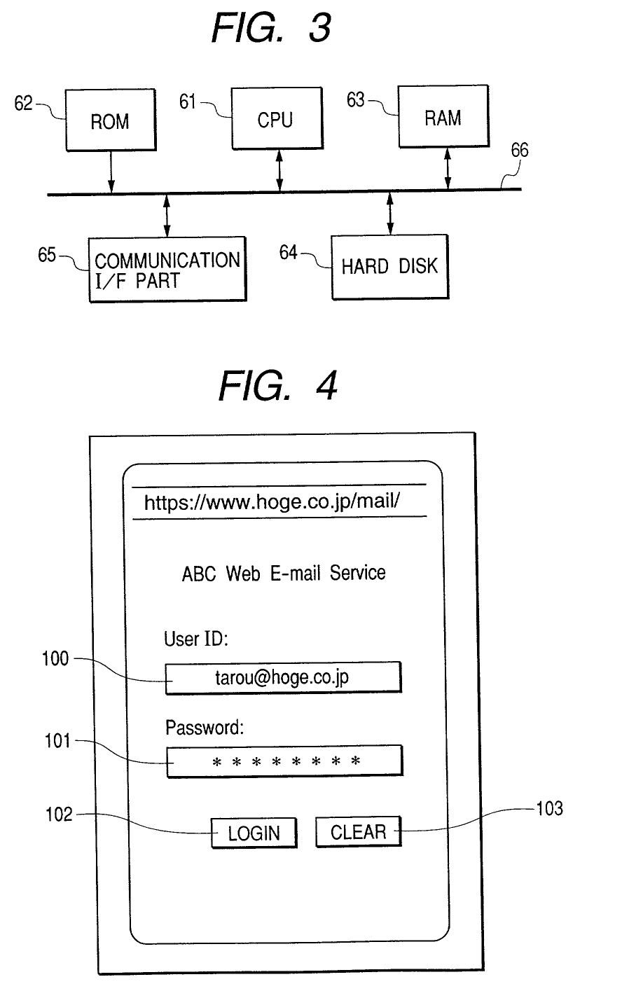

The application server 2, as shown in FIG. 3, comprises a CPU 61, a ROM 62, a RAM 63, a hard disk 64, and a communication I/F part 65, and these devices are connected through a bus 66. In the ROM 62, a boot program and the like is stored, and in the hard disk 64, there are stored a system program (OS), and various application programs.

The CPU 61 develops a system program in the hard disk 64 on the RAM 63 based on the boot program of the ROM 62, by developing and executing the application program on the hard disk 64 on the RAM 63 as occasion demands, various processings corresponding to a Web server service, Web E-mail service and the like are carried out.

As shown in FIG. 1, in the ROM 52 of the information terminal 1, as a program characteristic to the present invention, programs corresponding to the following services are stored. Of these services, a Web browser service 10 is a service which receives data coded with a Hypertext Markup Language (HTML) through a Hypertext Transfer Protocol (HTTP), interprets and appropriately displays it by a certain format, or performs data transmission.

A display service 11 is a service which displays various data on the display device 54. An input service 12 is a service which detects that a certain domain on a digitizer was pressed by a pen and the like, and provides an input information to various services. An encryption communication service 13 interlocks with the Web browser service 10 and the like, and establishes an encryption communication with the application server 2.

Furthermore, as shown in FIG. 1, in the hard disk 64 of the application server 2, as a program characteristic to the present invention, a program corresponding to the following services are stored.

Of these services, a Web server service 20 is a service which reads from the inside of the application server 2 and transmits and the like data coded with the Hypertext Markup Language (HTML) required by the Hypertext Transfer Protocol (HTTP). An encryption communication service 21 interlocks with the Web server service 20 and the like, and establishes an encryption communication (SSL and TLS, for example) with the Web browser service 10.

Furthermore, a secret key management service 22 is a service which manages, in a data of the Web server service 20 on the application server 2, the Web E-mail service data for example, to enable to use a secret key corresponding to a public key encryption necessary to decrypt a code applied to said E-mail data, or provide digital signature on a created E-mail.

Further, hereupon, for the convenience of description, the public key and the secret key of the public key cryptosystem is identifiably constituted by an E-mail address used by user. Furthermore, these public key and secret key always exist in pair as one and only key.

Furthermore, a Web E-mail service 23 operates on the Web server service 20, codes an E-mail application with the Hypertext Markup Language so as to display it on the Web browser service 10, and enables operations such as receiving, creation, transmission and saving of E-mails from the Web browser service 10.

Furthermore, the application server 2, in addition to the aforesaid services, may also be constituted to provide services such as database retrieval, remote access, file management and the like.

FIG. 4 is a diagram showing, to the Web E-mail service 23 on the Web server service 20 of the application server 20, an example of the window of the information terminal 1 in the case where the window is accessed by the Web browser service 10 of the information terminal 1.

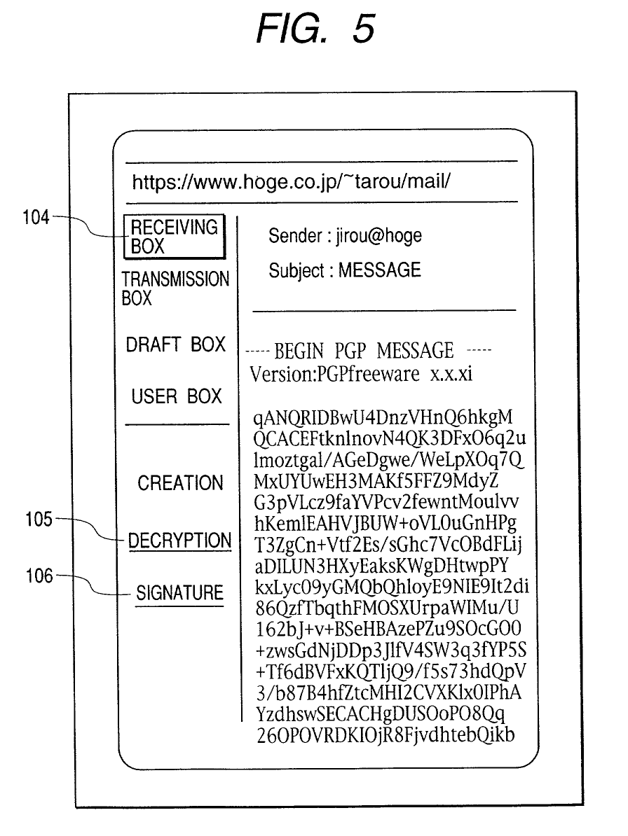

FIG. 5 is a diagram showing an example of the window of the information terminal 1 in the case where an access by the Web browser service 10 of the information terminal 1 to the Web E-mail service 23 on the Web server service 20 of the application server 2 is succeeded, and the mail in the receiving box of the Web E-mail is opened.

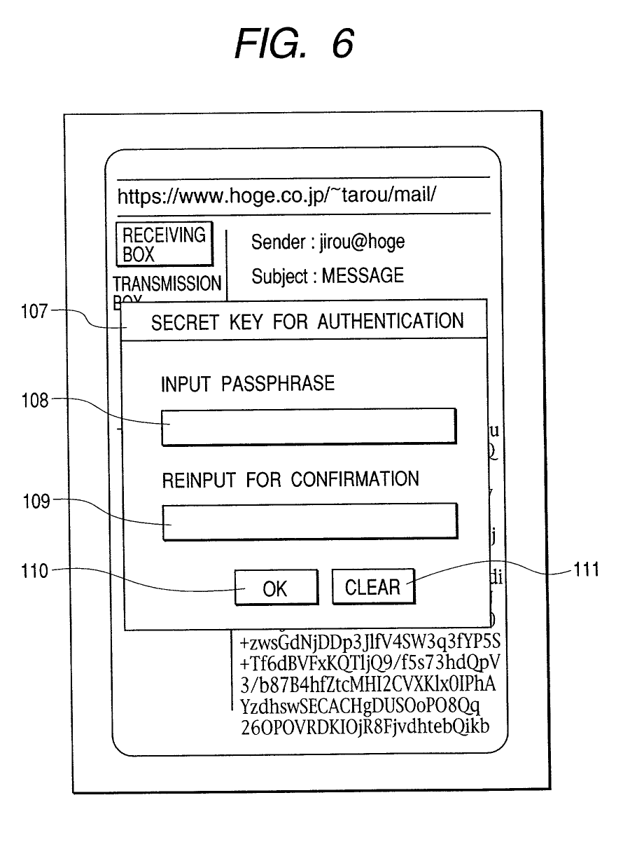

FIG. 6 is a diagram showing an example of the allowance authentication window for use of the secret key transmitted from the application server 2 and displayed on the information terminal 1, when the access by the Web browser service 10 of the information terminal 1 to the E-mail service 23 on the Web server service 20 of the application server 2 is succeeded, and a decryption software button is pressed.

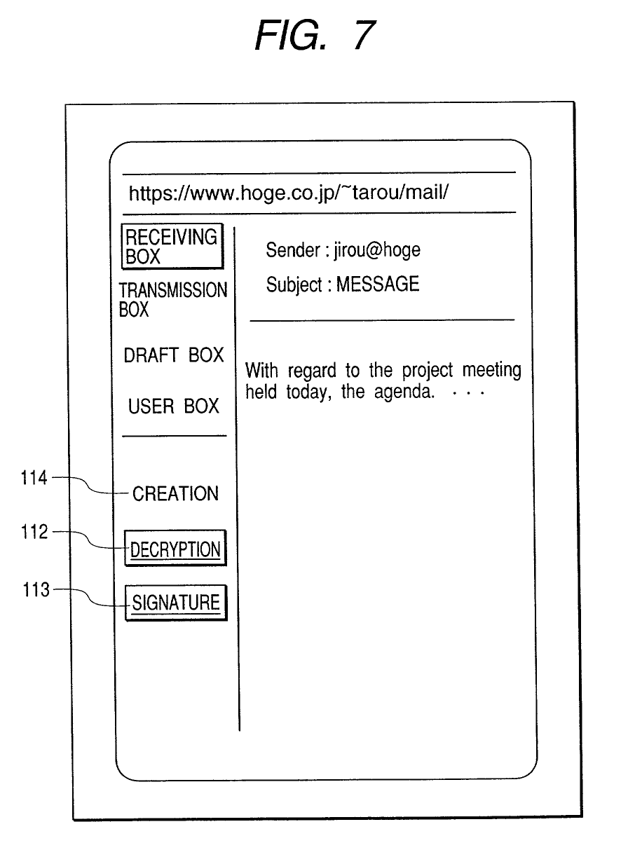

FIG. 7 is a diagram showing an example of the window of the information terminal 1 in the case where the allowance authentication for use of the secret key is succeeded, when the access by the Web browser service 10 of the information terminal 1 to the Web E-mail service 23 on the Web server service 20 of the application server 2 is succeeded, and the decryption software button is pressed.

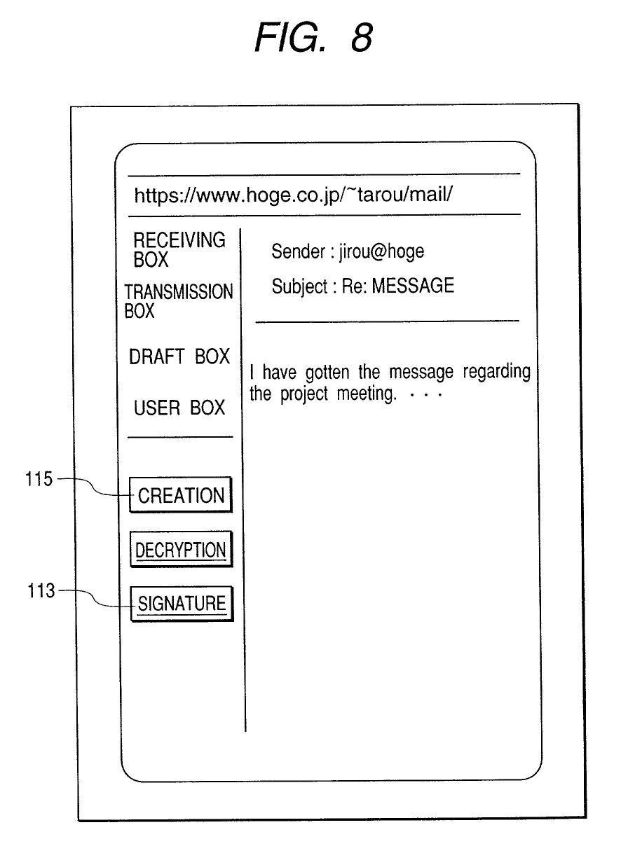

FIG. 8 is a diagram showing an example of the window the information terminal 1 in the case where a new E-mail is created, after the access by the Web browser service 10 of the information terminal 1 to the Web E-mail service 23 on the Web server service 20 of the application server 2 is succeeded, and the access to the allowance authentication for use of the secret key is also succeeded.

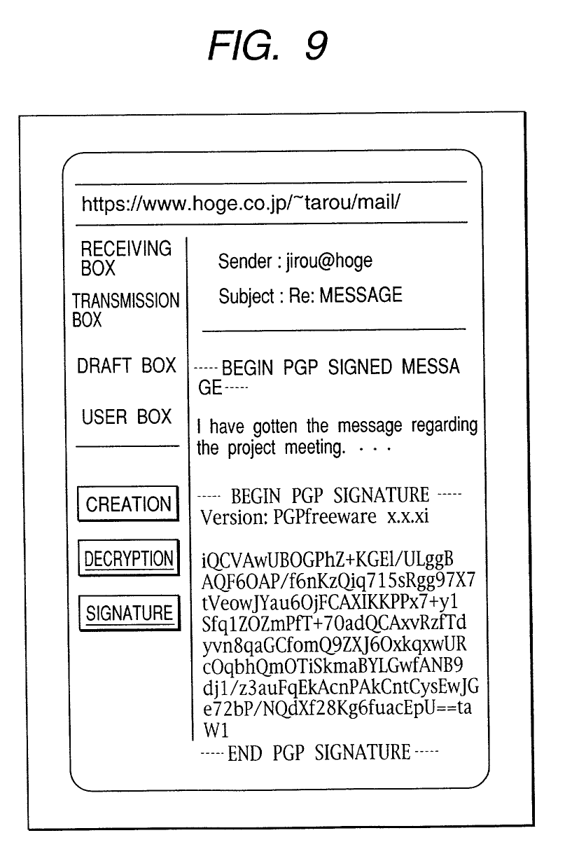

FIG. 9 is a diagram showing an example of the window of the information terminal 1 in the case where, after a new E-mail is created as FIG. 8, a signature software button is pressed, and a digital signature is given to a Web E-mail.

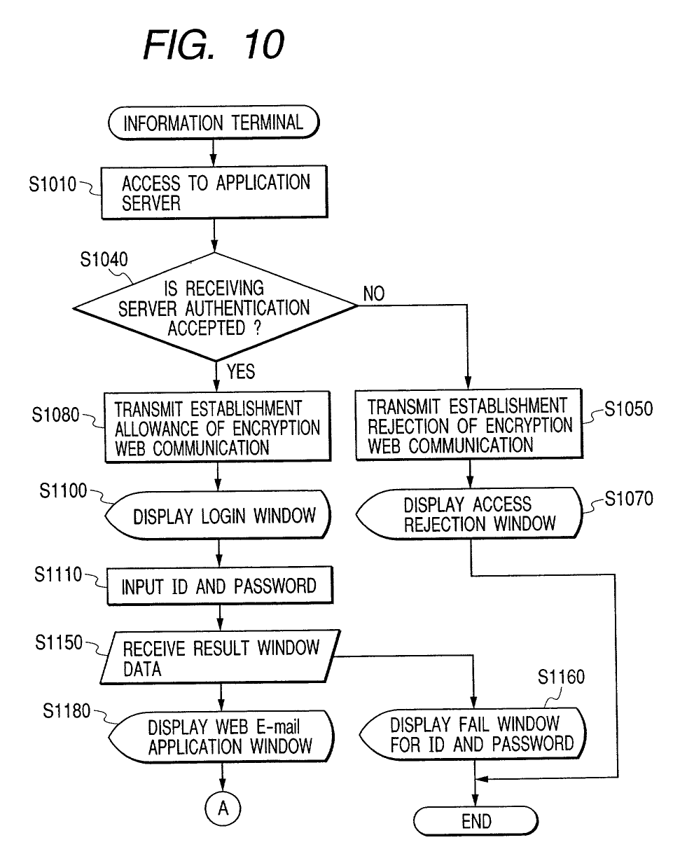

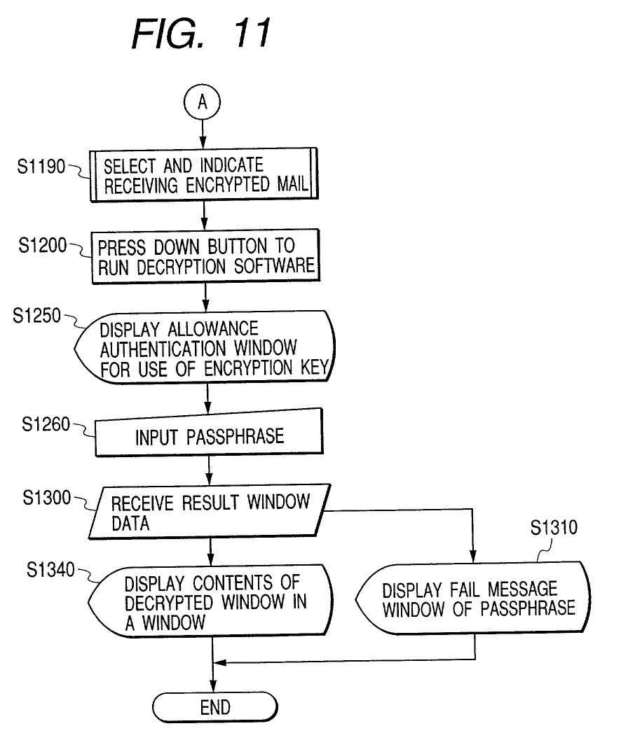

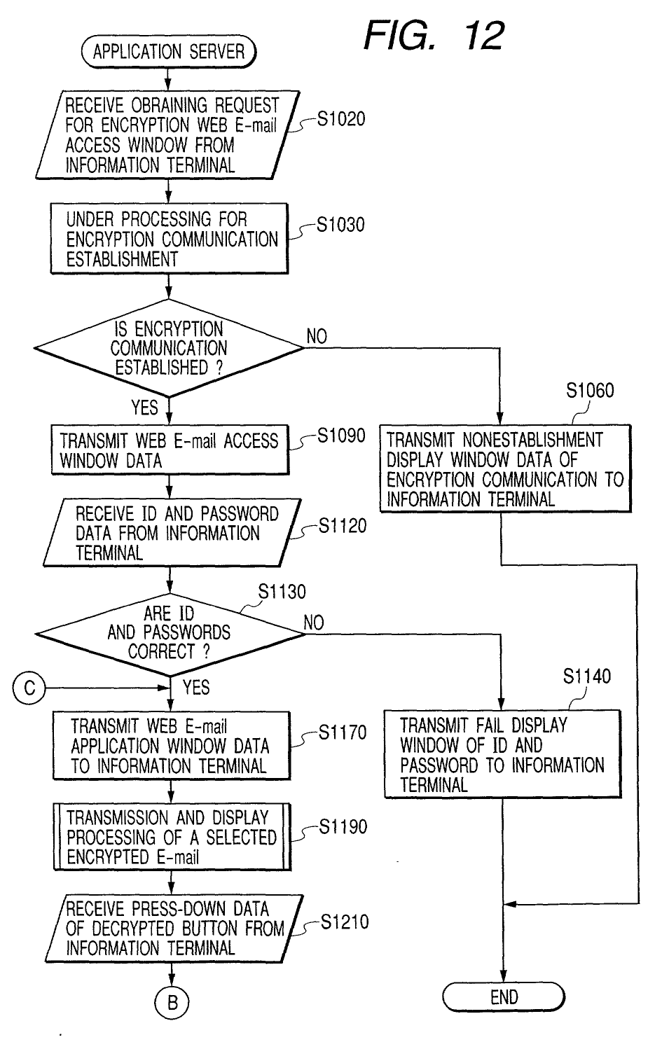

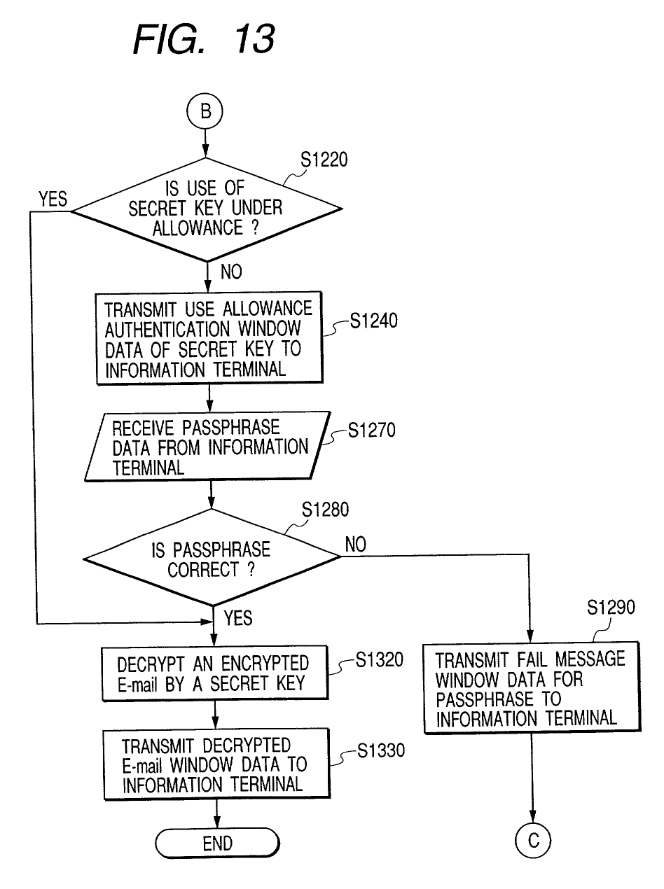

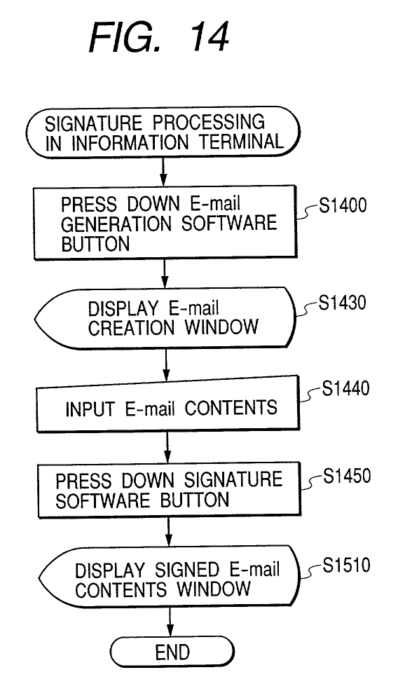

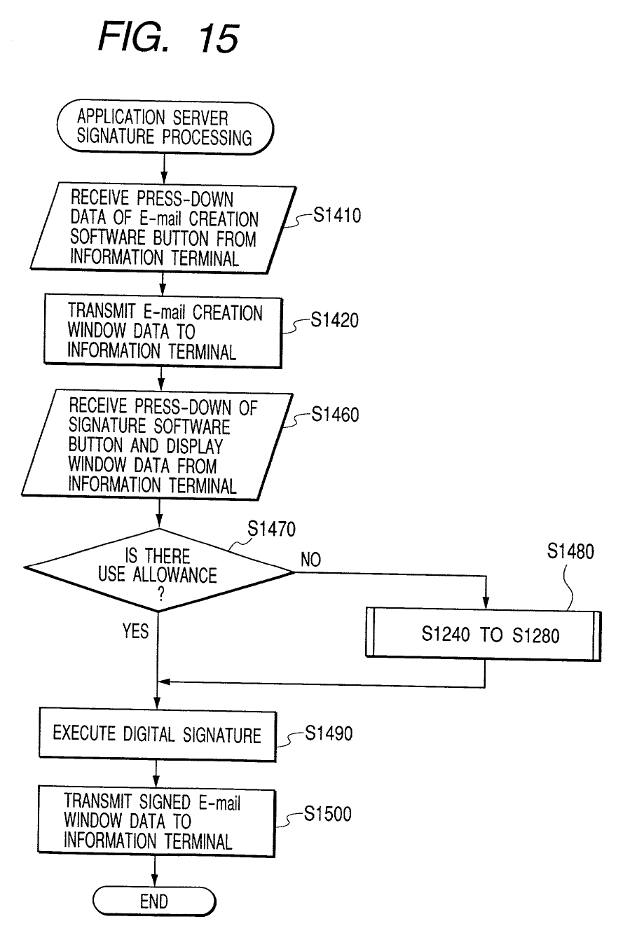

FIGS. 10 to 11 indicate flowchart showing a processing of the information terminal 1 in the first embodiment of the present invention. FIG. 12 is a flowchart showing a processing of the application server 2 in the first embodiment of the present invention. FIG. 13 is a flowchart continued from FIG. 12. FIG. 14 is a flowchart showing a signature processing in the information terminal 1, and FIG. 15 is a flowchart showing a signature processing in the application server 2.

Next, processings characteristic to the present invention will be described in detail according to the flowcharts of FIGS. 10 to 15.

First, by the browser service 10 of the information terminal 1, an address Uniform Resource Locators (URL) or Uniform Resource Indicators (URI) is inputted and transmitted through an input service 12 (step S1010 of FIG. 10). As an input method of the input service 12, a software keyboard and the like can be cited.

The application server 2, when a message for securely calling the Web E-mail service 23 from the information terminal 1 is received (step S1020 of FIG. 12), transmits to the information terminal 1 an application server authentication necessary for an establishment allowance of encryption Web communication from an encryption communication service 21 through the Web server service 20, and tries to establish the encryption Web communication (such as SSL and TLS)(step S1030 of FIG. 12).

The information terminal 1, when the application server authentication is received, inspects by an encryption communication service 13 whether said application server authentication is acceptable using the public key of a signatory list (also called a route certificate) of Certificate Authority (CA) trusted by the user who retains it in the information terminal 1 in advance (step S1040 of FIG. 10).

As a result, in the case where the received application server authentication is not acceptable to said information terminal 1, a message to the effect that the establishment of the encryption Web communication is rejected is transmitted to the application server 2 (step S1050 of FIG. 10). The encryption communication service 21 of the application server 2, upon receiving the message to the effect that the establishment of the encryption Web communication is rejected, transmits a display data showing non-establishment of the encryption Web communication to the information terminal 1, and ends the operation (step S1060 of FIG. 12). The Web browser service 10 of the information terminal 1 displays the received display data showing non-establishment of the encryption Web communication, and ends the operation (step S1070 of FIG. 10).

In the case where the received application server authentication is acceptable to said information terminal 1, a message to the effect that the establishment of the encryption Web communication is transmitted the application server 2 (step S1080 of FIG. 10). The encryption communication service 21, upon receiving a message to the effect that the establishment of the encryption Web communication is acceptable, exchanges a remaining information necessary for the encryption Web communication with the encryption communication service 13, thereby to establish the encryption Web communication, starts a session program (hereafter referred to as a session) dedicated to perform an encryption communication processing with said information terminal 1, and causes said session to manage the processing of the encryption data communication with said information terminal 1.

This session has a role corresponding to a session layer of a 7-layer structure specified by Open System Interconnection (OSI) which is a modeled structure of a communication program. Furthermore, this session is closed naturally when communication with the information terminal 1 ends normally, but, also in the case where the communication with the information terminal 1 is discontinued, this session has a function to automatically close after a fixed time.

Further, in the present invention, allowance for use of the secret key is authenticated using the encryption Web communication continuously established between the information terminal 1 and the application server 2 as a unit, in the case the session is closed, that is, in the case where the encryption Web communication established between a certain information terminal 1 and the application server 2 is closed, allowance the authentication for use of the secret key is also cancelled simultaneously, as will be stated later.

After the encryption Web communication is established, the Web server service 20 of the application server 2 transmits an access window data to the Web E-mail service 23 required by the information terminal 1 in the step S1010 of FIG. 10, to the information terminal 1 (step S1090 of FIG. 12).

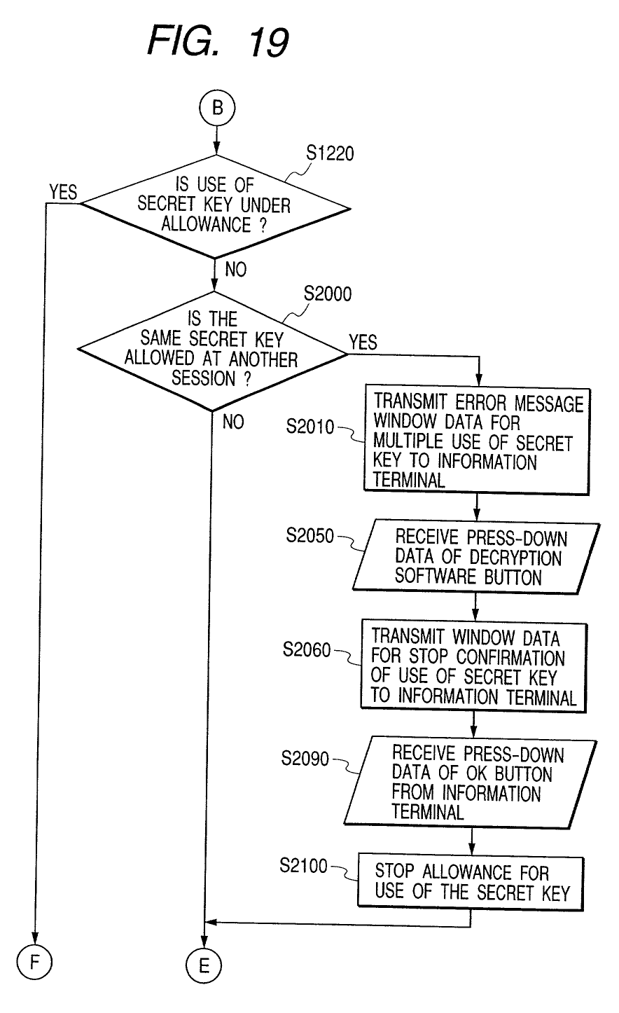

The Web browser service 10 of the information terminal 1 analyzes the access window data to the received E-mail service 23, and displays by the display service 11 (Step S1100 of FIG. 19). Contents of this display are as shown in FIG. 4, for example.

Hereupon, in the information terminal 1, a user, using the input service 12, inputs a respectively suitable user ID and a password into an input column 100 of the user ID and a password input column 101 of FIG. 4, in the case where a login software button 102 is pressed, the Web browser service 10 transmits said display data and the input data to the Web server service 20 of the application server 2 (step S1110 of FIG. 10). As a concrete input method by the input service 12, for example, a software keyboard and the like can be cited.

The Web server service 20 of the application server 2, upon receiving the input data such as the display data, user ID and password (step S1120 of FIG. 12), judges whether the received user ID and password are the user ID and the password registered in the application server 2 as the correct data accessible the Web E-mail service 23 (step S1130 of FIG. 12).

As a result, if the received user ID and the password are fail data, a fail display window data indicating to that effect is transmitted to the Web browser service 10 of the information terminal 1 (step S1140 of FIG. 12). The Web browser service 10 of the information terminal 1, upon receiving the fail display window data (step S1150 of FIG. 10), analyzes such fail display window data, and displays by the display service 11 (step S1160 of FIG. 10).

In the case where the input data such as the user ID and the password received from the information terminal 1 are correct, the Web server service 20 of the application server 2 starts the Web E-mail service 23, and transmits the display window data of that Web E-mail service 23 to the Web browser service 10 of the information terminal 1 (step S1170 of FIG. 12).

The Web browser service 10 of the information terminal 1, upon receiving the display window data of the Web E-mail service 23 (step S1150 of FIG. 10), analyzes such display window date, and displays by the display service 11 (step S1180 of FIG. 10).

Hereupon, normally, an E-mail which is not encrypted is displayed. Furthermore, by selecting a received title list and the like of the E-mail on the information terminal 1 (by pressing the button of link), a window data indicating contents of the E-mail selected from the Web E-mail service 23 through the Web server service 20 of the application server 2 is transmitted to the Web browser service 10 of the information terminal 1 (step S1190 of FIG. 12), and displayed by the display service 11 (step S1190 of FIG. 11). In this embodiment, an encrypted E-mail is selected by the information terminal 1, and such encrypted E-mail is displayed in the information terminal 1, as shown in FIG. 5.

In the case where this encrypted E-mail is decrypted, a decryption software button 105 shown in FIG. 5 is pressed (step S1200 of FIG. 11). In this case, that the decryption software button 105 on the display service 11 is pressed is notified to the Web browser service 10, and the Web browser service 10 transmits information to the effect that the decryption software button 105 is pressed and the display data to the Web server service 20 of the application server 2.

When the information to the effect that the decryption software button 105 is pressed and the display data are received by the Web server service 20 of the application server 2 (step S1210 of FIG. 12), the Web E-mail service 23 inquires from the secret key management service 22 and confirms as to whether the use of the secret key is allowed in the present session (step S1220 of FIG. 13).

As a result, in the case where the use of the secret key is allowed in the present session, that is, in the case where the present session continues as the session where the use is allowed once, the program proceeds to a step S1320 of FIG. 13. Furthermore, whether or not the same session is judged by an identifier such as a session number.

In the case where the use of the secret key is not allowed in the present session, a passphrase request window data for allowance authentication for use of the secret key is transmitted to the Web browser service 10 of the information terminal 1 through the Web server service 20 (step S1240 of FIG. 13).

The Web browser service 10 of the information terminal 1, upon receiving the passphrase request data for allowance authentication for use of the secret key, analyzes such window data, and displays by the display service 11 (refer to the step S1250 of FIG. 11, and FIG. 6).

Hereupon, the user, using the input service 12 of the information terminal 1, inputs a passphrase into both of a passphrase input column 108 and a confirmation input column 109 in a passphrase input window 107 on the window of the information terminal 1, and presses an OK software button 110 (step S1260 of FIG. 11). Furthermore, when a clear software button 111 is pressed, a character-string inputted theretofore into the passphrase input column 108 and the confirmation input column 109 is cleared. As a concrete input method of the input service 12, a software keyboard and the like can be cited.

The Web browser service 10 of the information terminal 1 receives the passphrase request window data for allowance authentication for use of the secret key and a passphrase data from the input service 12, and transmits to the Web server service 20 of the application server 2.

The Web E-mail service 23 of the application server 2 transfers the passphrase request window data for allowance authentication for use of the secret key and the passphrase data received through the Web server service 20 to the encryption key management service 22, and requests collation with the passphrase of the secret key of the session user of said information terminal 1 (step S1280 of FIG. 13).

As a result, if the passphrase is a fail data, the Web E-mail service 23 transmits a message window data to the effect that the passphrase is a fail data to the information terminal 1 through the Web server service 20 (step S1290 of FIG. 13), ends a passphrase processing, and returns to a condition before the decryption software button 105 is pressed. The Web browser service 10 of the information terminal 1, upon receiving the message window data to the effect that the passphrase is a fail data (step S1300 of FIG. 11), analyzes such data, and displays by the display server 11 (step S1310 of FIG. 11).

In the case where the passphrase is correct, the Web E-mail service 23 decrypts the secret key allowed for use of a copy of E-mail concerning a decryption request (step S1320 of FIG. 13), and transmits a display shape change data of a decryption software button 112 and a signature software button 113 to the Web browser service 10 of the information terminal 1 through the Web server service 20 (step S1330 of FIG. 13). Furthermore, the display shape change data of the decryption software button 112 and the signature software button 113 is transmitted to indicate that the allowance for use of the secret key is obtained in the present session, and this secret key use allowance information is saved until said session is closed as an additional information of the present session.

The Web browser service 10 of the information terminal 1, upon receiving the display data of the decrypted E-mail and the display shape change data of the decryption software button 112 and the signature software button 113, analyzes these data, and displays by the display service 11 (refer to the step S1340 of FIG. 11, and FIG. 7).

As described above, based on the condition of an input of the passphrase used when encrypting the secret key, by executing the allowance authentication for use of the secret key, it becomes possible to simplify user operations.

Next, in the Web server service 20 of the application server 2, there is a session which controls a dialogue processing and the like with the information terminal 1, in the case where the secret key use allowance of the user of the information terminal 1 is retained, procedures for processing the digital signature to the created E-mail are described.

When the information terminal 1 is in a condition of FIG. 7, the user presses down an E-mail generation software button 114 (step S1400 of FIG. 14). Thereupon, the Web browser service 10 of the information terminal 1 receives a press down information of the E-mail generation software button 114 from the input service 12, and transmits it to the Web server service 20 of the application server 2, together with the display data of FIG. 7.

The Web E-mail service 23 of the application server 2, upon receiving the information of the press down of the E-mail generation software button 114 and the display data of FIG. 7 through the Web server service 20 (step S1410 of FIG. 15), transmits an E-mail creation window data and a creation software highlight data to the Web browser service 10 of the information terminal 1 through the Web server service 20 (step S1420 of FIG. 15).

The Web browser service 10 of the information terminal 1 analyzes the received E-mail creation window data and the creation software highlight data, and displays by the display service 11 (refer to the step S1430 of FIG. 14, and FIG. 8).

In the case where the information terminal 1 is in a display condition of FIG. 8, the user inputs the contents of an E-mail into a contents field using the input service 12 (step S1440 of FIG. 14). In this case, an input method of the input service 12 is not specified in particular, but a pen input, a keyboard, a voice input and the like by a digitizer can be considered.

After the contents of the E-mail are inputted, the signature software button 113 of FIG. 8 is pressed down (step S1450 of FIG. 14). Thereupon, the Web browser service 10 of the information terminal 1 receives the press down information of the signature software button 113 from the input service 12, and transmits it to the Web server service 20 of the application server 2, together with the display data of FIG. 8.

The Web E-mail service 23 of the application server 2, upon receiving the press down information of the signature software button 113 and the display data of FIG. 8 through the Web server service 20 (step S1460 of FIG. 15), inquires to the secret key management service 22 as to whether own session retains the secret key use allowance (step S1470 of FIG. 15).

As a result, in the case where the own session does not retain the secret key use allowance, the same processing as the steps S1240, S1270, and S1280 of FIG. 13 is executed (step S1480 of FIG. 15).

In the case where the own session retains the secret key use allowance, the Web E-mail service 23 of the application server 2 causes the secret key management service 22 to execute a digital signature on a document of an E-mail concerning receiving and creation using the secret key concerning the use allowance of the above (step S1490 of FIG. 15), and transmits the display window data of the contents of the E-mail executed by the digital signature to the Web browser service 10 the information terminal 1 through the Web server service 20 (step S1500 of FIG. 15).

The Web browser service 10 of the information terminal 1 analyzes the display window data of the contents of the E-mail concerning the received digital signature, and displays by the display service 11 (refer to the step S1510 of FIG. 14, and FIG. 9).

As described above, without decrypting an encrypted E-mail by managing the secret key of the public key cryptosystem in an information terminal, by decrypting the encrypted E-mail by managing with the application server 2 and transmitting to the information terminal, it becomes possible to read the encrypted E-mail from a number of information terminals.

Furthermore, by saving the information of the secret key use allowance acquired as the correct passphrase is inputted from the information terminal 1 as the session information of the application service 2, it becomes possible to continuously execute decrypting of the encrypted E-mail and the digital signature, and in the case where said session is closed, said secret key use allowance is also cancelled, and it becomes possible to improve the secrecy of the encrypted E-mail.

Second Embodiment

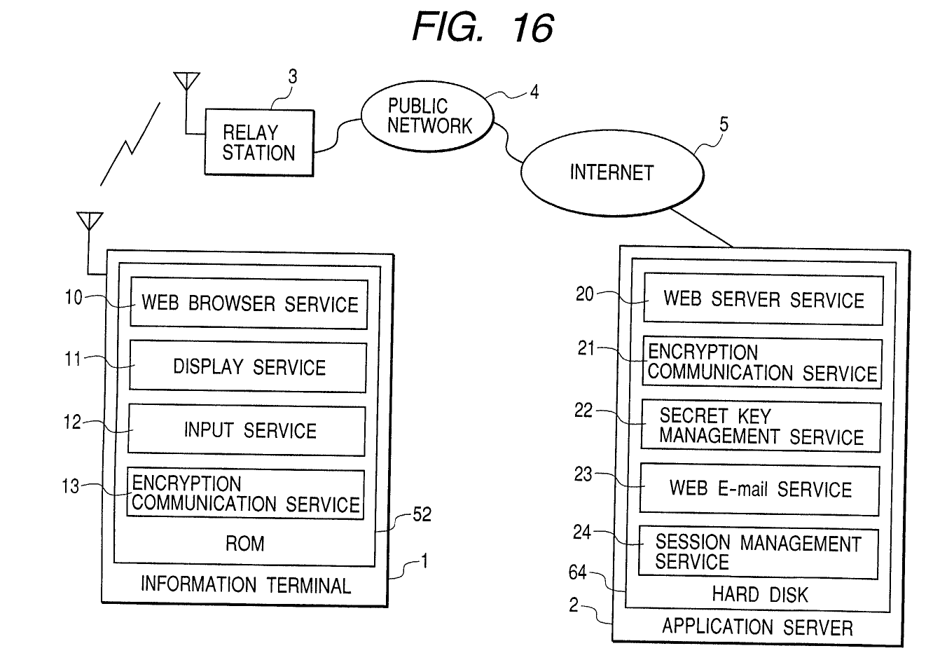

The present invention will hereunder be described further with reference to FIGS. 16 to 20 of the second embodiment.

FIG. 16 is a structural diagram of the communication system to which the second embodiment is applied, and is different in that a session management service 24 is added to the application server 2, as compared to the structural diagram concerning the first embodiment shown in FIG. 1.

This session management service 24 is a service to manage the session as a unit for executing a communication processing separately from each of the information terminal 1 when a plurality of the information terminal 1 gains access to the Web server service 20 of the application server 2.

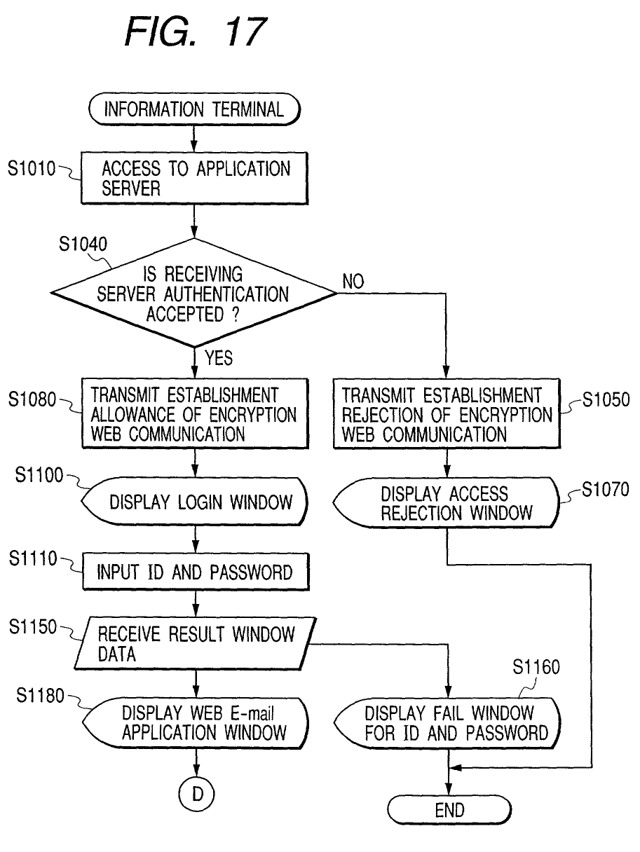

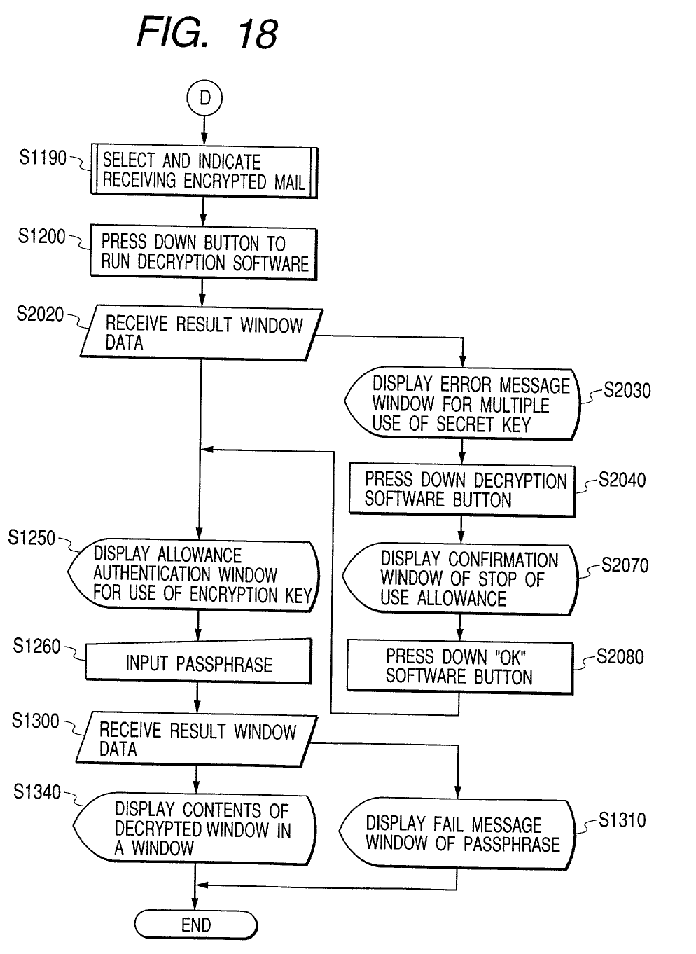

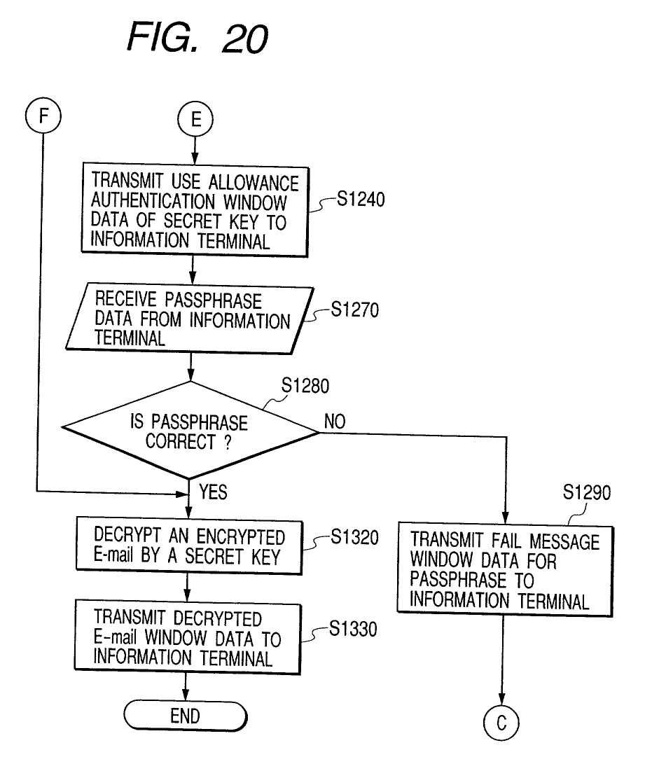

FIGS. 17 to 18 denote the flowchart showing the processing of the information terminal 1 in the second embodiment. FIGS. 19 to 20 denote the flowchart showing the processing of the application server 2 in the second embodiment, and this flowchart shows only the flow continued from the flowchart of FIG. 12 described in the first embodiment.

Hereunder, the processing in the case where the session management service 24 is operated will be described. Furthermore, after logging on in the Web E-mail service 23 of the application server 2 from the information terminal 1 and displaying the encrypted E-mail, a series of operations of the information terminal 1 and the application server 2 until the decryption software button 105 is pressed down are the same as the first embodiment.

In the case where the use of the secret key is not allowed for the present session, the Web E-mail service 23 of the application server 2 inquires the session management service 24 about whether the secret key use allowance used for decrypting the Web E-mail required by said information terminal 1 is used at another effective session (step S2000 of FIG. 19).

As a result, in the case where the secret key use allowance used for decrypting the Web E-mail required by said information terminal 1 is used for another effective session, the Web E-mail service 23 of the application server 2 transmits a secret key multiple use error message to the Web browser service 10 of the information terminal 1 through the Web server service 20 so that the user presses down the decryption software button 105 again.

The Web browser service 10 of the information terminal 1 analyzes the window data of the received secret key multiple use error message, and displays by the display service 11 (steps S2020 and S2030 of FIG. 18). The user, upon looking at this secret key multiple use error message, recognizes that the secret key use allowance remains in the session when the previous error is ended, and presses down the decryption software button 105 displayed in the information terminal 1 again (step S2040 of FIG. 18). The press down information of this decryption software button 105 is transmitted to the Web server service 20 of the application server 2 through the Web browser service 10, together with the display data of the secret key multiple use error message.

The Web E-mail service 23 of the application server 2, upon receiving the press down information of the decryption software button 105 and the window data of the secret key multiple use error message through the Web server service 20 (step S2050 of FIG. 19), transmits the window data of the secret key stop confirmation message to the Web browser service 10 of the information terminal 1 (step S2060 of FIG. 19).

The Web browser service 10 of the information terminal 1 analyzes the window data of the received secret key use stop confirmation message, and displays by the display service 11 (step S2070 of FIG. 18). Hereupon, when the user pressed down the OK software button (step S2080 of FIG. 18), the press down information is transmitted to the Web server service 20 of the application server 2 through the Web browser service 10, together with the window data of the secret key use stop confirmation message.

The Web E-mail service 23 of the application server 2, upon receiving the press down information of the OK software button and the window data of the secret key use stop confirmation message through the Web server service 20 (step S2090 of FIG. 19), notifies the stop of the secret key use allowance corresponding to the user of the aforesaid information terminal 1 to the session management service 24 and the secret key management service 22 (step S2100 of FIG. 19), upon receiving its response, moves to the step S1240, and transmits the secret key use allowance authentication message window data to the Web browser service 10 of the information terminal 1 through the Web server service 20.

In the step S2000 of FIG. 19, in the case where the use allowance of the secret key used to decrypt the Web E-mail service required by said information terminal 1 is distinguished as not used in another effective session, the step immediately moves to the aforesaid step S1240, and transmits the secret key use stop allowance authentication message window data to the Web browser service 10 of the information terminal 1 through the Web server service 20.

After the steps of S1240, the information terminal 1 and the application server 2 execute the same processing as those of the first embodiment.

Furthermore, by prohibiting a multiple use where the same secret key is used simultaneously between a plurality of sessions (encryption communication), it becomes possible to prevent the wrong use and the like of the secret key by others.

Furthermore, the present invention can be transformed in many ways without limiting to the aforesaid embodiments. For example, if the public key is one which can identify an individual without identifiably constituting by an E-mail address, it may be identifiably constituted by the pension number, employee number, tax payment number and the like, for example. Furthermore, a language of the data communicated between the Web browser service 10 of the information terminal 1 and the Web server service 20 of the application server 2, without being limited to HTML, may use a multimedia contents descriptive language such as Wireless Application Protocol (WAP), Extensible Markup Language (XML), the Extensible Hypertext Markup Language (XHTML), Hypertext Preprocessor (PHP) and the like.

Furthermore, in authenticating the secret key use, justification may be determined using a biometric information such as voice information (voiceprint), finger print, and retina (iris), instead of determining the justification using the passphrase applied when decrypting the secret key.

Furthermore, in the aforesaid embodiment, as an encryption communication service executed before the application server 2 provides the Web E-mail service, SSL (TLS) is used, but as a Web encryption communication executed between the application server 2 and the information terminal 1, an encryption communication such as s-http, Secure-IP and the like may be used.

Furthermore, in the case where the session ended with an error, when the secret key concerning the use allowance is not used for more than a specified time, it is also possible to automatically cancel the use allowance of said secret key.

As have been described above, according to the present invention, it becomes possible to read the Web E-mail encrypted from a number of information terminals, and the convenience is improved.

What is claimed is:

1. A communication system having a server for providing a Web E-mail service to a client, wherein said server comprises:
management means for managing a key for decrypting an encrypted E-mail;
decrypting means for decrypting said encrypted E-mail using said managed key; and
transmission control means for controlling said decrypted E-mail thereby to transmit said decrypted E-mail to said client through a Web.

2. The communication system according to claim 1, wherein said server further comprises:
authentication means for executing authentication of the use allowance of said key to said client, and
said decrypting means decrypts said encrypted E-mail in the case where the use allowance is authenticated by said authentication means.

3. The communication system according to claim 2, wherein said authentication means provides said client with a window data to authenticate the use allowance of said key.

4. The communication system according to claim 2, wherein said authentication means authenticates the use allowance using a passphrase inputted from said client.

5. The communication system according to claim 2, wherein said authentication means authenticates the use allowance using a biometrics information inputted from said client.

6. The communication system according to claim 1, wherein said server further comprises encryption communication means for establishing and communicating a Web encryption communication when communicating with said client through the Web.

7. The communication system according to claim 2, wherein said server further comprises the encryption communication means for establishing and communicating the Web encryption communication when communicating with said client through the Web, and transmission means for transmitting the use allowance by said authentication means and the E-mail decrypted by said decrypting means to said client after the Web encryption communication is established by said encryption communication means.

8. The communication system according to claim 7, wherein said authentication means authenticates the use allowance of said key in units of a session of an encryption communication continuously established between said client and a server.

9. The communication system according to claim 8, wherein said authentication means stops said authenticated use allowance, in the case where at least either the case where said encryption communication is ended with an error or the case where said encryption communication has passed a fixed time is satisfied.

10. The communication system according to claim 1, wherein said server further comprises signature means for executing a digital signature to an E-mail required for the digital signature by said client.

11. The communication system according to claim 1, wherein said server further comprises:
management means for managing whether said key is under multiple use, and
said management means comprises stop means for stopping the use allowance of said session under multiple use in the case where said session is judged to be under multiple use.

12. The communication system according to claim 1, wherein the key for decrypting said encrypted E-mail is a secret key in a code of a public key cryptosystem.

13. The communication system comprising:
management means for managing a key for decrypting an encrypted E-mail;
decrypting means for decrypting said encrypted E-mail using said managed key; and
a client receiving a Web E-mail service from a server including transmission control means for controlling said decrypted E-mail so as to transmit to said client through the Web,
wherein said client comprises the use allowance means for executing use allowance of the key for decrypting said encrypted E-mail to said server, and receiving means for receiving the E-mail decrypted by said server through the Web.

14. A method for controlling a communication system including a server for providing the client with the Web E-mail service, comprising:
a management step of managing a key for decrypting an encrypted E-mail;
a decrypting step of decrypting said encrypted E-mail using said managed key; and
a transmission control step of controlling said decrypted E-mail to transmit to said client, in the server.

15. A method for controlling the communication system according to claim 14, further comprises an authentication step of authenticating use allowance of said key to said client in the server, wherein said encrypted E-mail is decrypted in said decrypting step in the case where the use allowance is authenticated in said authentication step.

16. A method for controlling the communication system according to claim 15, wherein, in said authentication step, a window data for authenticating the use allowance of said key is supplied to said client for authentication.

17. A method for controlling the communication system according to claim 15, wherein, in said authentication step, the use allowance is authenticated using a passphrase inputted from said client.

18. A method for controlling the communication system according to claim 15, wherein, in said authentication step, the use allowance is authenticated using biometrics information inputted from said client.

19. A method for controlling the communication system according to claim 14, wherein, in said server, the method further comprises an encryption communication step of establishing and communicating the Web encryption communication when communicating with said client through the Web.

20. A method for controlling the communication system according to claim 15, in said server, further comprising the encryption communication step of establishing and communicating the Web encryption communication when communicating with said client through the Web, and a transmission control step of transmitting use allowance in said authentication step and the E-mail decrypted by said decrypting step to said client after the Web encryption communication is established in said encryption communication step.

21. A method for controlling the communication system according to claim 20, wherein, in said authentication step, the use allowance of said key is authenticated in units of a session of an encryption communication continuously established between said client and a server.

22. A method for controlling the communication system according to claim 21, wherein, in said authentication step, said authenticated use allowance is stopped in the case when at least either the case where said encryption communication is ended with an error or the case where said encryption communication has passed a fixed time is satisfied.

23. A method for controlling the communication system according to claim 14, further comprising a signature step of executing the digital signature to the E-mail required for the digital signature from said client in said server.

24. A method for controlling the communication system according to claim 14, further comprising a step of executing a management step of managing whether said key is under multiple use in the server, said management step including a stop step of stopping the use allowance of the session under multiple use in the case where the session is judged to be under multiple use.

25. A method for controlling the communication system according to claim 14, wherein the key for decrypting said encrypted E-mail is a secret key in an encryption of a public key cryptosystem.

26. A method for controlling a communication system including a client receiving a Web E-mail service from a server, comprising a step of executing a management step of managing a key for decrypting an encrypted E-mail, a decrypting step of decrypting said encrypted E-mail using said managed key and a transmission control step of controlling said decrypted E-mail so as to transmit to said client in the server, and comprising a step of executing a use allowance step of executing the use allowance of the key of decrypting said encrypted E-mail, and a receiving step of receiving the E-mail decrypted by said server in the client.

27. A computer executable control program of a communication system including a server for providing a Web E-mail service to a client, said program comprising a management step of managing a key for decrypting an encrypted E-mail, a decrypting step of decrypting said encrypted E-mail using said managed key, and a transmission control step of controlling said decrypted E-mail so as to transmit to said client.

28. A control program of a communication system including a client receiving a Web E-mail service through a Web from a server, comprising a step of executing a management step of managing a key for decrypting an encrypted E-mail, a decrypting step of decrypting said encrypted E-mail using said managed key, and a transmission step of controlling said decrypted E-mail so as to transmit to said client in the server, and said client comprising a step of executing a use allowance step of executing the use allowance of the key for decrypting said encrypted E-mail to said server, and a receiving step of receiving the E-mail decrypted by said server in the client.

29. A storage medium storing a computer executable control program of a communication system including a server of providing a Web E-mail service to a client, the program comprising a step of executing a management step of managing a key for decrypting said encrypted E-mail using said managed key, and a transmission control step of controlling said decrypted E-mail so as to transmit to said client in a server.

30. A storage medium storing a control program of a communication system including a client receiving a Web E-mail service through a Web from a server, wherein the program comprises a step of executing a management step of managing a key for decrypting an encrypted E-mail, a decrypting step of decrypting said encrypted E-mail using said managed key in the server, and a transmission control step of controlling said decrypted E-mail so as to transmit to said client, and wherein the program comprises a step of executing a use allowance step of executing the use allowance of a key for decrypting said encrypted E-mail to said server and a receiving step of receiving the E-mail decrypted by said server.
